(19) United States
(12) Patent Application Publication
(10) Pub. No.: US 2007/0066692 A1
(43) Pub. Date: Mar. 22, 2007

(54) METHOD AND PRODUCT FOR RECYCLING LAMINAR ELEMENTS OF CAR ROOF TRIMS

(76) Inventors: Luis Miguel De Juan Saiz, Burgos (ES); Santos Tabliega Garcia, Burgos (ES)

Correspondence Address: NOTARO AND MICHALOS, 100 DUTCH HILL ROAD, SUITE 110, ORANGEBURG, NY, 10962-2100, US

(21) Appl. No.: 11/470,311

(22) Filed: Sep. 6, 2006

(30) Foreign Application Priority Data
Sep. 16, 2005 (ES) P200502266

(51) Int. Cl. C08J 11/04

(52) U.S. Cl. 521/40

(57) ABSTRACT

A method and resulting product, includes shredding laminar elements to obtain a shredded product, mixing this shredded product with a binder product that has one or more solid resins to obtain a mix that contains the shredded product and the binder product, and submitting this mix to a heat moulding process to obtain the resulting heat moulded product.

### TECHNICAL AREA OF THE INVENTION

The invention comes within the field of recycling car trims.

### BACKGROUND TO THE INVENTION

Vehicle roof trims usually consist of a laminar structure comprising several layers formed to fit the shape of the vehicle's roof. For example, a typical roof trim could comprise a layer (normally made form fabric) on the surface visible from the vehicle interior, an intermediate reinforcement layer (normally glass fibre) and a semi-rigid, low density structural layer (normally polyurethane or polyester foam). On the concealed surface there is normally a layer of paper, polythene-coated flixeline or the like. Some or all of the intermediate layers (that is, the layers between the visible surface and the concealed surface) may be duplicated, their order may be varied and additional layers may be added depending on the specific properties required for the trim. Further, between the layers (or between some of the layers) there may be an adhesive to keep them together.

The manufacture of this type of trim starts with a laminar element that is cut to provide a product with a contour that matches the vehicle or roof in which it is to be installed. In this cutting phase, plentiful excess laminar material is usually produced (that is, the off-cuts of the laminar element) which are thrown away or recycled. Equally, when entire trim parts are produced that are defective, these are thrown away or recycled. When the vehicles are scrapped, it may also be necessary or convenient to recycle the trims.

However, the separation of the laminar structure into its components is problematic (the laminar structure includes a variety of materials which are also joined together, for example, with adhesive, in such a way that makes separation difficult). Because of this, various recycling methods have been developed based on shredding the trim or excess trim in order to produce agglomerated products useful in, for example, building, where traditional products may be replaced with wooden agglomerated panels.

The manufacture of the semi-rigid polyurethane layer usually involves a process called free foaming in an open mould in which a polyol and an isocyanate are mixed and react to produce a polyurethane foam mass. The resulting foam is semi-rigid (to provide stiffness to the piece of which it forms part) and flexible (for easy moulding); it usually has a density of between 20 and 35 kg/m³.

Both the base and the upper part of this polyurethane block are then disposed of and the block thus formed is laminated to the required thickness, providing the semi-rigid layers to be included in the trim's laminar structure (the first layers may be of lesser quality than the rest and have unsuitable mechanical properties for specific trims, in which case they can be recycled or used in other trims, producing more off-cut material which can be recycled). The scrapped parts (that is, the lower part and the upper part of the block obtained in the foaming process) may be recycled.

Recycling processes are known for vehicle roof trims which comprise shredding the trims to be recycled, adding or incorporating an agglomerating material consisting of liquid isocyanate, and compacting or heat moulding the product into multi-use sheets, for example, for building, thus replacing traditional agglomerated sheets. WO-A-99/02321 describes a process of this type. Other examples of processes that include the use of isocyanate and/or polyisocyanate are described in WO-A-2004/052608, U.S. Pat. No. 4,382,108 and EP-A-0251267.

In these known procedures, isocyanate is used as a binder or agglutinant. This may be due in part to the fact that isocyanate is one of the products used to make the polyurethane foam which often makes up one of the roof trim layers, so that the same product is used in recycling and in manufacturing, which may at first sight seem advantageous.

However, the use of isocyanate in recycling could have certain disadvantages. One the one hand, it is a product that could be expensive and renders the manufacturers dependent on isocyanate, which may affect the price. Thus, an alternative to isocyanate could be interesting.

On the other hand, a drawback with isocyanate is that in order for it to act as an agglomerant, agglutinant or binder, it must be vaporised, but the droplets of vapour thus formed are not able to adequately impregnate the finest powder produced when the cover trim is shredded (or, at least, the vapour is not ideal for this purpose). This may be because the minimum size of the vapour droplets is too large for the small size of the powder grains. Using liquid isocyanate and spraying it on the shredded product to be recycled causes balls to form, since the isocyanate is sticky. It is possible to reduce this problem by adding water but it may be difficult to achieve complete impregnation.

Instead of using isocyanate with water, a polyol is often used which, together with the isocyanate, may form polyurethane as a binder; in fact there are some polyurethanes specifically for use in agglomerated products. Nevertheless, these also fail to provide suitable impregnation and rigidity of product.

### DESCRIPTION OF THE INVENTION

A first aspect of the invention refers to a method of recycling laminar car roof trim elements. These laminar elements may comprise off-cuts (for example, the parts cut off when forming trims from laminar structures and/or scrapped defective trims) produced in the trim manufacturing process, and/or trims recovered from vehicles, for example, when vehicles are scrapped. The method involves the following steps:
The laminar elements are shredded to produce a shredded product.
The shredded product is mixed with a binder product to provide a mix comprising the shredded product and the binder product.

This mix is submitted to a heat moulding process to produce a heat moulded product.

According to the invention, the binder product comprises at least one solid resin.

It has been proved that the use of solid resins as a binder product can provide a series of advantages compared to traditional methods:
The rigidity of the heat moulded product can be increased compared to products made using traditional methods based on the use of isocyanate: The rigidity provided by the solid resins may be greater than that provided by the isocyanate. This may be important, since for agglomerated products for building use, rigidity is a fundamental property, perhaps the most important one, followed by resistance to damp.
The use of solid resins allows reducing the manufacturing cost of the product. For example, currently, the cost of a phenolic resin and urea formaldehyde mix is less than the cost of the same amount of isocyanate.
Better impregnation can be achieved using solid resins as the binder. In the mixer, the impregnation of all the materials that are agglutinated is better with solid resins in fine grains (for example, with those mentioned as an example in this text) than with liquid binders such as isocyanate. This may be due to the difficulty of achieving a suitable vaporisation of the isocyanate; it may be difficult to achieve a sufficiently fine vaporisation.
Greater flexibility in choosing suppliers of raw materials is also achieved.

The solid resin or solid resins used according to the invention may completely replace the isocyanates or polyisocyanates used in conventional methods to provide a method in which the binder product has no isocyanates or polyisocyanates.

A suitable binder product for use in the invention comprises phenolic resin and urea formaldehyde, for example, more than 25% in weight of phenolic resin and more than 25% in weight of urea formaldehyde, for example, between 40% and 60% in weight of phenolic resin and between 40% and 60% in weight of urea formaldehyde, for example, 50% in weight of phenolic resin and 50% in weight of urea formaldehyde.

Alternatively or as a complement, at least one solid resin in the binder product can be a lignosulphonate resin, for example, of sodium or magnesium.

Alternatively or as a complement to the above mentioned resins, other resins may also be used.

The step of submitting the mix to a heat moulding process may comprise the step of submitting the mix to a heat moulding process in a mould at a temperature of between 175° C. and 250° C. (in applications that use isocyanate as the binder, this temperature is usually of the order of between 110° C. and 140° C.).

The step of submitting the mix to a heat moulding process may be carried out in such a way that a heat moulded object with the desired shape is obtained, for example, in the form of a sheet or already in the form of a piece for a car, or similar. The sheet may be given a coating on one or both surfaces.

The step of shredding or grinding the laminar elements may comprise a first shredding or grinding step in which the laminar elements are shredded to provide pieces with an initial average size followed by a second shredding or grinding step to obtain a product comprising pieces of a secondary average size smaller than the first average size. The pieces with the first average size may have one longer side between 3 and 8 cm in length and the pieces with the secondary size may have one longer side between 0.5 and 2 cm in length. That is, the pieces can be said to have a granularity or largest dimension of between 3 and 8 cm and between 0.5 and 2 cm, respectively.

The method may comprise the step of compacting the product comprising pieces of the first average size obtained from the first shredding step to provide batches comprising said pieces of a first average size. The method may also comprise the step of transporting these batches between an installation in which the first shredding stage is carried out and another installation in which the second shredding step is carried out.

Thus, the first shredding step can be carried out directly in correspondence with a trim production installation. Once the waste from manufacture has been shredded, it is compacted to form batches of the highest possible density to optimise transport to a waste material handling plant.

The machine that carries out the shredding may be associated with (for example, contiguous with) a compacting machine to compact the waste, forming a batch. Compacting trailers do exist but the compacting density is usually less than that of the batches that can be obtained together with the shredding phase. It is true that the recycled product could be ground for transport, which could be carried out in a tank, compacting it with compressed air. Nevertheless, to extract the ground product, suction may not be sufficient to de-compact it and there would be problems to unload the tank completely. Therefore, the option of generating batches may be preferable. The batches may consist of shredded pieces of sizes between 3 and 8 cm, for example, with sides of approximately 5 cm.

In a typical case, the uncompacted waste could have a density of 35 kg/m³, the compacted waste in the trailer could have a density of 160 kg/m³ and the compacted waste in batches could have a density of 320 kg/m³.

In the installation in which the recycling process is carried out, the material in the batches may be shredded or ground to convert the large pieces into small ones. The resulting grain size after grinding may be selected in the mill according to the application for which the ground material is to be used. A grid may be used to sift the ground material. Each mill may be specific for a type of material and to provide different sizes of pieces as a result of grinding, it would be possible, for example, to:
keep the same sieve and change the grinding time and/or speed, or,
change the sieve grid.

In many applications, the optimal grain size may be less than 1 cm², without considering the length of the glass fibre which may be greater than 1 cm (when this type of laminar material is shredded, the glass fibre may appear loose in the shredded product with greater lengths than those of the sides of the other pieces of the shredded product).

A very coarse grinding may prevent the resin from impregnating the waste correctly and a very fine milling may not provide more rigidity. It may be preferable to carry out the grinding or shredding in such a way that the resin impregnates as much as possible, until a finer grain size will not provide rigidity to the agglomerate.

The step of shredding the laminar elements may comprise the step of shredding these laminar elements and, in addition, polyurethane elements. The shredding of both types of elements may be carried out in the same machine or in different machines.

Before the step of shredding the laminar elements, the method may comprise the step of obtaining laminar elements to be shredded from elements cut in the manufacture of roof trims for cars. This step may comprise obtaining the cut laminar elements from the multi-layer structures designed to form roof trims.

Alternatively and/or as a complement, before the step of shredding the laminar elements, the method may comprise the step of obtaining laminar elements to be shredded from defective trims and/or from the roof trims of scrapped vehicles and/or the step of obtaining laminar elements to be shredded from off-cuts from polyurethane blocks, for example, the upper and lower parts of a block obtained in the process of free foaming for manufacturing trims.

The method of the invention may comprise the step of adding at least one load before the step of submitting the mix to a heat moulding process, so that the mix submitted to the heat moulding comprises at least one load. The load may be introduced at any time in the procedure prior to heat moulding. The load may comprise one or more fibrous materials (for example, glass fibre and/or rock wool) and/or one or more foams (for example, glass fibre, polyethylene, polystyrene and/or polyurethane; for example, foams of the type used for vehicle seats may be included). The load may be added so that it constitutes, for example, between 20% and 80% of the weight of the mix to be submitted to the heat moulding process.

The binder product may be supplied in a sufficient quantity to constitute, for example, between 15% and 50% of the weight of the mix to be submitted to the heat moulding process.

For example, a possible composition of the mix to be submitted to the heat moulding may be 20% of binder product and 80% of recycled product (of the laminar structure for trims, optionally including polyurethane removed from a block obtained in the production of polyurethane).

To increase the rigidity, the proportion of binder product may be increased. The proportion of resins may be increased to 50% or more of the mix.

Another possibility may be a product that comprises 40% of recycled material, 20% of binder product (resins) and 40% of one or more loads (for example, foams) . In practice, the average expert in the matter will choose the most suitable proportions depending on the required properties for the product.

The step of submitting the mix to a heat moulding process may be carried out in a mould chosen to obtain an agglomerated product with a surface with at least one engraving or similar. In fact, the product may be given any convenient form according to the use for the product and provided that it is compatible with the materials being used. For example, the sheet obtained may be given ribs or similar configurations to reinforce the product and/or edges with configurations that allow the joining of the product by tongue and groove or similar. The surface of the sheet may also be given an anti-slip texture, which is useful if the sheet is to be used in, for example, the floors of goods vehicles. Equally, the sheet may be given whatever linings are considered suitable according to the proposed specific application. One especially interesting application may be for the floors of goods vehicles.

Another aspect of the invention refers to a heat moulded agglomerated product that includes a multi-layer material from laminar elements in car roof trims. The agglomerated product may also include a binder product that comprises at least one solid resin.

The above description regarding the method is also applicable to the product, mutatis mutandis.

For example, the binder product may include neither isocyanate nor polyisocyanate.

The binder product may, for example, comprise phenolic resin and urea formaldehyde, for example, more than 25% by weight of phenolic resin and more than 25% by weight of urea formaldehyde, for example, between 40% and 60% by weight of phenolic resin and between 40% and 60% by weight of urea formaldehyde, for example, 50% of each.

Alternatively or as a complement, the solid resin may comprise, for example, at least one lignosulphonate resin.

The product may have been obtained by, for example, heat moulding in a mould at a temperature of between 175° C. and 250° C. The product may be in the form of a sheet, plank or panel, with plain or engraved surfaces (obtained by so configuring the mould), for example.

The product may comprise pieces of recycled material with an average size in which the longest size of the pieces is between 0.5 and 2 cm long.

The product may also comprise polyurethane elements from the cutting phase of a polyurethane block obtained by free foaming.

The product may also comprise one or more loads. These loads may comprise fibrous material (for example, glass fibre and/or rock wool) and/or foam or foams (for example, polyethylene and/or polystyrene and/or polyurethane) . The loads may constitute, for example, between 20% and 50% by weight of the product.

The binder product may constitute, for example, between 15% and 50% by weight of the agglomerated product.

The product may be obtained using the method of the invention.

The product may have at least one surface with a covering and/or be an element of a car trim.

### DESCRIPTION OF THE FIGURE

To complement the description and for the better understanding of the properties of the invention according to a preferred example of its practical embodiment, this description is accompanied by a figure as an integral part of it, to illustrate but not to limit it, showing:

FIG. 1. Shows a schematic view of the method of the invention.

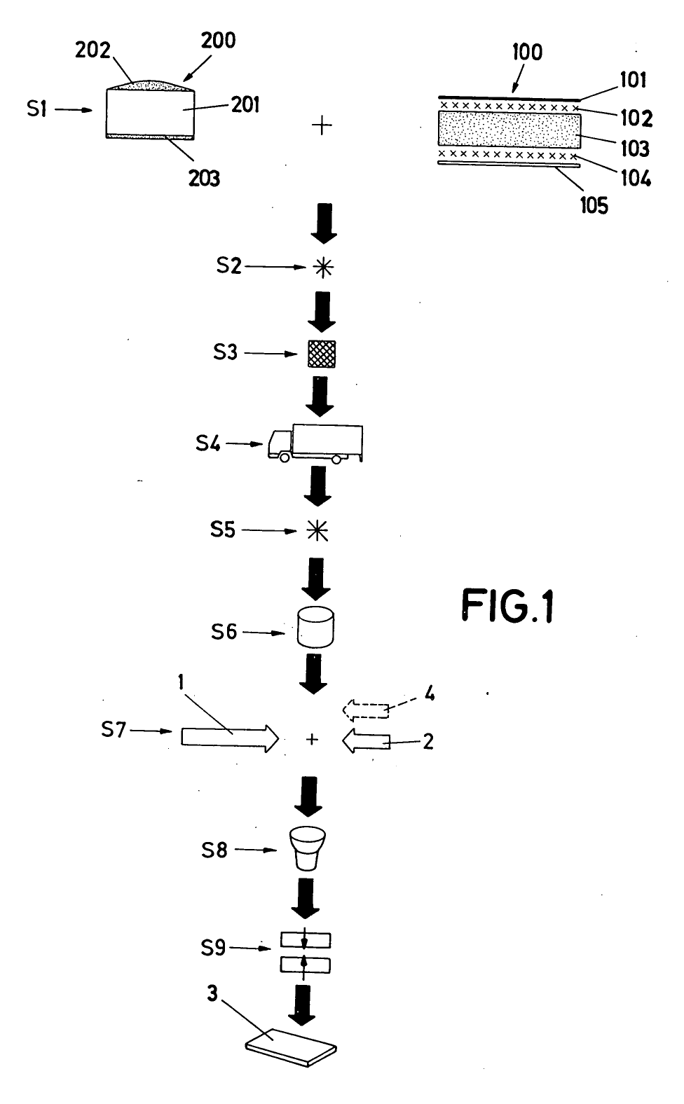

### PREFERRED EMBODIMENT OF THE INVENTION

In accordance with a possible embodiment of the invention, this starts by obtaining (in step S1) the material to be recycled. This material is obtained from off-cuts 100 of the laminar structures used to produce roof trims and/or scrapped defective trims. These off-cuts 100 or trims may have a laminar structure that includes, for example, a layer of cellulose 101 on their concealed surface, a layer of glass fibre 102, a semi-rigid layer of polyurethane 103, another layer of glass fibre 104 and a layer of fabric 105 making up the visible surface. There may also be layers of adhesive to keep these layers together. Logically, this is only one example of a possible configuration of the raw material for the process.

Off-cuts 202 and 203 from polyurethane blocks 200 may also be used, the central parts 201 of which are used to provide semi-rigid layers 102 of polyurethane to make roof trims.

In the next step (S2), the raw material is shredded in a shredder that may be installed in the same factory or premises in which the trims are produced. In this step, a first shredding is carried out to produce shredded pieces of the material to be recycled, with sides approximately 5 cm long (for example, the shredding may be carried out so that the longest side of the pieces measures on average 5 cm, or a maximum of 5 cm). The glass fibre may be longer than the sides of the other pieces; in practice, the glass fibre is often loose in the shredded material.

Then, for the reasons described above, comes the compacting stage (S3), which may be carried out in the shredding machine itself to obtain compact batches of pieces of the shredded material. The batches may have a density of about 320 kg/m³. The batches may then be transported (S4) to an installation in which they are subjected to a new shredding or grinding (step S5) in a mill specially designed for this process to provide smaller pieces. The exact sizes are chosen as a function of the properties required. The size may be controlled using sieve grilles and/or by controlling the grinding process itself (speed, grinding time, etc) . The smaller pieces (which may have sides with a length of about 1 cm, for example) may be stored (S6) in a silo or similar or may pass directly to the mixing phase (S7) in which the shredded material (1) is mixed with solid resins (2) which may comprise 50% phenolic resin and 50% urea formaldehyde (although it is also possible to use other solid resins, for example, lignosulphonate resin).

The solid resins are supplied as fine grains. For example, it has been proved that good results may be obtained by supplying the phenolic resin with a grain size with which, using a 75 μm sieve, 12.42% is retained. Logically, for optimal results, it may be necessary to use resins with grain sizes that match the sizes of the shredded pieces. Also in this step, it is possible to add load material (4), for example, fibrous material or foams, which may also be waste materials from the manufacture of car parts.

Using, for example, a gravity doser, the mix is then dosed (S8) and added to a mould for heat moulding (S9) to obtain, for example, an agglomerated sheet (3).

The sheet may then be submitted to a treatment in which one or both sides are covered. It is also possible to form the product so that an agglomerated product is obtained that constitutes an element of car trim (for example, for the rear shelf, the floor, etc).

The proportions of the product to be recycled, the solid resins and any loads may be varied as a function of the properties to be obtained for the agglomerated product. It is considered that the optimal densities for the product obtained may be between 500 and 900 kg/m³ and that the optimal thickness may be less than 40 mm.

It has been proved that the sheets obtained allow PVC profiles to adhere with good results, especially using polyurethane glues. The surfaces of the products resulting from the process can be very smooth, allowing good finishes to be obtained by painting the surfaces.

It has also been proved that the products obtained with the described procedure may provide good resistance to water, may possibly be less flammable than other types of products obtained with traditional methods, easily pass the so-called screw pull-out tests and also have good high-frequency noise absorption properties.

In this text, the word “comprises” and its variants (such as “comprising” etc) must not be interpreted exclusively, that is, they do not exclude the possibility that the description includes other elements, steps, etc.

Moreover, the invention is not limited to the specific examples that have been described; it also covers, for example, variations that may be made by the average expert in the matter (for example, regarding the choice of materials, sizes, components, configuration, etc), within the contents of the claims.

1. A method of recycling laminar elements of car roof trims, that comprises the following steps:
shredding (S2, S5) the laminar elements (100), to obtain a shredded product (1);
mixing (S7) this shredded product (1) with a binder product (2) to obtain a mix that comprises the shredded product and the binder product;
submitting (S9) this mix to a heat moulding process to obtain a agglomerated product (3);
characterised in that the binder product (2) comprises at least one solid resin.

2. Method according to claim 1, characterised in that the binder product (2) includes neither isocyanate nor polyisocyanate.

3. Method according to claim 1, characterised in that the binder product comprises phenolic resin and urea formaldehyde.

4. Method according to claim 3, characterised in that the binder product comprises more than 25% by weight of phenolic resin and more than 25% by weight of urea formaldehyde.

5. Method according to claim 4, characterised in that the binder product comprises between 40% and 60% by weight of phenolic resin and between 40% and 60% by weight of urea formaldehyde.

6. Method according to claim 1, characterised in that at least one solid resin comprises at least one lignosulphonate resin.

7. Method according to claim 1, characterised in that the step of submitting this mix to a heat moulding process comprises submitting this mix to a heat moulding process in a mould at a temperature of between 175° C. and 250° C.

8. Method according to claim 1, characterised in that the step of submitting this mix to a heat moulding process is carried out in such a way as to obtain a heat moulded object in the form of a sheet.

9. Method according to claim 1, characterised in that the step of shredding the laminar elements comprises a first shredding step (S2) in which the laminar elements are shredded to obtain a product that comprises pieces with an initial average size, followed by a second shredding step (S5) in which a product is obtained that comprises pieces with a second average size, smaller than the initial average size.

10. Method according to claim 9, characterised in that the pieces with said first average size have a longer side of between 3 and 8 cm long, and in that the pieces with this second average size have a longer side of between 0.5 and 2 cm long.

11. Method according to claim 9, characterised in that it comprises the step (S3) of compacting the product which comprises pieces with an initial average size obtained in the first shredding step in such a way as to obtain batches that comprise these pieces with an initial average size.

12. Method according to claim 11, characterised in that it comprises the step (S4) of transporting these batches between the installation in which the first shredding step (S2) is carried out and another installation in which the second shredding step (S5) is carried out.

13. Method according to claim 1, characterised in that the step of shredding (S2, S5) the laminar elements (100) comprises the step of shredding these laminar elements (100) and, also, polyurethane elements (202, 203).

14. Method according to claim 1, characterised in that it comprises, prior to the step of shredding the laminar elements, the step (S1) of obtaining laminar elements to be shredded from off-cuts in the production of car roof trims.

15. Method according to claim 14, characterised in that this step (S1) of obtaining laminar elements to be shredded comprises obtaining off-cut laminar elements from multi-layer structures for forming roof trims.

16. Method according to claim 1, characterised in that it comprises the step of adding at least one load (4), prior to the step of submitting (S9) the mix to a heat moulding process, so that the mix submitted to the heat moulding comprises said, at least one, load.

17. Method according to claim 16, characterised in that said load comprises at least one fibrous material.

18. Method according to claim 16, characterised in that this load comprises at least one foam.

19. Method according to claim 16, characterised in that said load is added so that it constitutes between 20% and 80% by weight of the mix submitted to the heat moulding process.

20. Method according to claim 1, characterised in that the binder product is supplied in sufficient amount to constitute between 15% and 50% by weight of the mix submitted to the heat moulding process.

21. Method according to claim 1, characterised in that the step of submitting (S9) this mix to a heat moulding process is carried out in a mould chosen to obtain a agglomerated product with a surface with at least one engraving.

22. Heat moulded agglomerated product that includes shredded multi-layer material (1) from laminar elements of car roof trims, the agglomerated product also comprising a binder product (2);
characterised in that the binder product (2) comprises at least one solid resin.

23. Agglomerated product according to claim 22, characterised in that the binder product includes neither isocyanate nor polyisocyanate.

24. Agglomerated product according to claim 22, characterised in that the binder product comprises phenolic resin and urea formaldehyde.

25. Agglomerated product according to claim 24, characterised in that the binder product comprises more than 25% by weight of phenolic resin and more than 25% by weight of urea formaldehyde.

26. Agglomerated product according to claim 25, characterised in that the binder product comprises between 40% and 60% by weight of phenolic resin and between 40% and 60% by weight of urea formaldehyde.

27. Agglomerated product according to 22, characterised in that said at least one solid resin comprises at least one lignosulphonate resin.

28. Agglomerated product according to claim 22, characterised in that the product has been obtained by heat moulding in a mould at a temperature of between 175° C. and 250° C.

29. Agglomerated product according to claim 22, characterised in that the product has the form of a sheet.

30. Agglomerated product according to claim 22, characterised in that it comprises pieces of recycled material with an average size in which the longest side of the piece is between 0.5 and 2 cm long.

31. Agglomerated product according to claim 22, characterised in that it also comprises polyurethane elements.

32. Agglomerated product according to claim 22, characterised in that it additionally comprises at least one load (4).

33. Agglomerated product according to claim 32, characterised in that said load comprises at least one fibrous material.

34. Agglomerated product according to claim 32, characterised in that said load comprises at least one foam.

35. Agglomerated product according to claim 32, characterised in that said load constitutes between 20% and 80% by weight of the agglomerated product.

36. Agglomerated product according to claim 22, characterised in that the binder product constitutes between 15% and 50% by weight of the agglomerated product.

37. A product according to claim 22, obtainable by a method according to any of claims 1-23.

38. A product according to claim 22, characterised in that it has a covering on at least one surface.

39. A product according to claim 22, characterised in that it is an element of a car trim.

40. Method according to claim 1, characterised in that it comprises, before the step of shredding the laminar elements, the step (S1) of obtaining laminar elements to be shredded from defective trims and/or from the roof trims of scrapped vehicles.

41. Method according to claim 1, characterised in that it comprises, before the step of shredding the laminar elements, the step (S1) of obtaining laminar elements to be shredded from off-cuts from polyurethane blocks.

42. Agglomerated product according to claim 22, characterised in that at least one surface of the product has an engraving.
